(19) United States
(12) Patent Application Publication
(10) Pub. No.: US 2024/0272332 A1
(43) Pub. Date: Aug. 15, 2024

(54) METHOD, DEVICE AND ELECTRONIC DEVICE OF DESIGNING ANTI-REFLECTION FILM OF METALENS

(71) Applicant: SHENZHEN METALENX TECHNOLOGY CO.,LTD, Shenzhen (CN)

(72) Inventors: Chenglong HAO, Shenzhen (CN); Fengze TAN, Shenzhen (CN); Jian ZHU, Shenzhen (CN)

(73) Assignee: SHENZHEN METALENX TECHNOLOGY CO.,LTD, Shenzhen (CN)

(21) Appl. No.: 18/646,663

(22) Filed: Apr. 25, 2024

Related U.S. Application Data
(63) Continuation of application No. PCT/CN2022/129846, filed on Nov. 4, 2022.

(30) Foreign Application Priority Data
Nov. 9, 2021 (CN) 202111320258.6

(51) Int. Cl. G02B 1/115; C03C 17/34; G02B 1/00

(52) U.S. Cl. CPC G02B 1/115; C03C 17/3417; G02B 1/002; C03C 2217/734

(57) ABSTRACT

Provided is a method, device and electronic device of designing an anti-reflection film of a metalens, the method including: step S1: selecting a filler material; step S2: calculating an effective refractive index and an equivalent extinction coefficient of respective filled unit cells; step S3: obtaining a refractive index and an extinction coefficient of the filled metalens by calculating a weighted average of the effective refractive index and the equivalent extinction coefficient of the respective filled unit cells; step S4: calculating a parameter of an initial anti-reflection film based on the refractive index and the extinction coefficient of the filled metalens; step S5: optimizing the parameter of the initial anti-reflection film to obtain an optimized parameter of the anti-reflection film.

### CROSS-REFERENCE TO RELATED APPLICATION

This application is a continuation of International Patent Application of PCT application serial No. PCT/CN2022/129846, filed on Nov. 4, 2022, which claims the benefit of priority from China Application No. 202111320258.6, filed on Nov. 9, 2021. The content of the aforementioned applications, including any intervening amendments thereto, are incorporated herein by reference.

### TECHNICAL FIELD

The present disclosure relates to the field of metasurface, in particular to a design and a coating method of an anti-reflection film of a metalens.

### BACKGROUND

An anti-reflection film is a kind of film deposited on the surface of the optical lens, its principle is constructive interference of the reflected light, so as to achieve the effect of anti-reflection or transmittance improvement of optical lenses. The film may be a single-layered film, or may be a multi-layered film.

In the relevant technology, the anti-reflection film is designed according to the material of the lens, and the designed anti-reflection film is deposited to the surfaces of lens by thermal evaporation in layer by layer.

Compared with the traditional lens, the surface of the metalens has a micro-nano structure to modulating the phase of incident light. In the coating process, the anti-reflection film with relevant technologies will not only be deposited on the micro-nano structure but also fill the air gap between the micro-nano structures, thus changing the phase of incident light through the metalens and affecting the optical performance of the metalens. Therefore, a method of designing an anti-reflection film of a metalens that does not change the optical performance of the metalens is urgently needed.

### SUMMARY

In view of the above technical problems, a method, device and electronic device of designing an anti-reflection film of a metalens is provided according to embodiments of the present disclosure, so as to overcome the problems in the related art.

In the first aspect, a method of designing an anti-reflection film of a metalens is provided by the embodiment of the present disclosure, the method includes:
step S1: selecting a filler material, the filler material is configured to fill an air gap between any two of structures of the metalens, so as to form a filled metalens with a flat surface, and the structures are in microscale or nanoscale; each structure and the filler material surrounding the each structure form one of filled unit cells;
step S2: calculating an effective refractive index and an equivalent extinction coefficient of respective filled unit cells;
step S3: obtaining a refractive index and an extinction coefficient of the filled metalens by calculating a weighted average of the effective refractive index and the equivalent extinction coefficient of the respective filled unit cells;
step S4: calculating a parameter of an initial anti-reflection film based on the refractive index and the extinction coefficient of the filled metalens;
step S5: optimizing the parameter of the initial anti-reflection film to obtain an optimized parameter of the anti-reflection film.

Optionally, a step of “calculating the effective refractive index and the equivalent extinction coefficient of the respective filled unit cells” includes:
step S201: calculating the effective refractive index and the equivalent extinction coefficient of the respective filled unit cells by a duty ratio method; or
step S202: obtaining the effective refractive index and the equivalent extinction coefficient of the respective filled unit cells by a direct calculation.

Optionally, a step of “optimizing the parameter of the initial anti-reflection film to obtain the optimized parameter of the anti-reflection film” includes:
step S501: analyzing the parameter of the initial anti-reflection film by a finite element analysis, so as to obtain an initial light field phase and initial transmittance of the metalens having the initial anti-reflection film;
step S502: performing an optimization iteration based on the initial light field phase and the initial transmittance, so as to obtain the optimized parameter of the anti-reflection film.

Optionally, a step of “calculating the effective refractive index and the equivalent extinction coefficient by the duty ratio method” includes:
calculating the effective refractive index and the equivalent extinction coefficient by following formulae:

$${n}_{1} ( λ ) = {ρ}^{′} {n}_{u} ( λ ) + {ρ}^{″} {n}_{f} ( λ ) ,$$

$${k}_{1} ( λ ) = {ρ}^{′} {k}_{u} ( λ ) + {ρ}^{″} {k}_{f} ( λ ) ,$$

$${ρ}^{′} + {ρ}^{″} = 1 ,$$

Where, λ represents a wavelength of light; n₁(λ) represents the calculated effective index of the filled unit cells; k₁(λ) represents the calculated equivalent extinction coefficient of the filled unit cells; nᵤ(λ) represents a refractive index of the structures; n_{f}(λ) represents a refractive index of the filler material; kᵤ(λ) represents an extinction coefficient of the structures; k_{f}(λ) represents an extinction coefficient of the filler material; ρ′ represents a ratio of an area of the structures to an area of the respective filled unit cells; and ρ″ represents a ratio of an area of the filler material to the area of the respective filled unit cells.

Optionally, a step of “obtaining the effective refractive index and the equivalent extinction coefficient by the direct calculation” includes:
calculating the effective refractive index and the equivalent extinction coefficient by following formulae:

$${n}_{1} ( λ ) = \frac{- {λ}^{2}}{2 π h} \cdot \frac{d φ ( λ )}{d λ} + 1 ,$$

$${k}_{1} ( λ ) = \frac{1}{h} ln \frac{T ( λ )}{{T}_{0}} ,$$

Where, h represents a height of the structures; T0 represents light intensity of incident light, φ (λ) represents a phase of the respective filled unit cells at different wavelengths; and T(λ) represents transmittance of the respective filled unit cells at different wavelengths.

Optionally, a step of “obtaining the refractive index and the extinction coefficient of the filled metalens by calculating the weighted average of the effective refractive index and the equivalent extinction coefficient” includes:
calculating the refractive index and the extinction coefficient of the filled metalens by following formulae:

$$n ( {λ}_{j} ) = {Σ}_{i = 1 , j = 1}^{M \times N} {C}_{ij} {n}_{i} ( {λ}_{j} ) ,$$

$$k ( {λ}_{j} ) = {Σ}_{i = 1 , j = 1}^{M \times N} {C}_{ij} {k}_{i} ( {λ}_{j} ) ,$$

Where, c represents a weighting coefficient; M represents a number of the filled unit cells in the metalens; N represents a number of selected wavelengths; n(λ) represents the effective refractive index; and k(λ) represents the equivalent extinction coefficient.

Optionally, the initial anti-reflection film comprises a plurality of initial anti-reflection layers; the parameter of the initial anti-reflection film comprises a number of the initial anti-reflection layers; a thickness of each initial anti-reflection layer and a material of each initial anti-reflection layer.

Optionally, the optimization iteration comprises an interior point method, a steepest descent method and a Newton's method.

Optionally, the anti-reflection film comprises a plurality of anti-reflection layers; the optimized parameter of the anti-reflection film comprises an optimized number of the anti-reflection layers; an optimized thickness of each anti-reflection layer and an optimized material of each anti-reflection layer.

Optionally, the number of layers of the initial anti-reflection film is four; the initial anti-reflection film comprises a first layer, a second layer, a third layer and a fourth layer sequentially arranged; the first layer is closest to a metasurface; the fourth layer is farthest from the metasurface; and
a material of the first layer and a material of the third layer are titanium oxide; a material of the second layer and a material of the fourth layer are silicon oxide.

Optionally, the first layer, the second layer, the third layer and the fourth layer at least satisfy a following relational expression:
a thickness of the fourth layer<a thickness of the first layer≤a thickness of the second layer<a thickness of the third layer.

Optionally, the optimized number of layers of the anti-reflection film is six; the anti-reflection film comprises a first layer, a second layer, a third layer, a fourth layer, a fifth layer and a sixth layer sequentially arranged; the first layer is closest to a metasurface; the sixth layer is farthest from the metasurface; and
a material of the first layer and a material of the fifth layer are titanium oxide; a material of the second layer, a material of the fourth layer and a material of the sixth layer are silicon oxide; and a material of the third layer is thallium oxide.

Optionally, the first layer, the second layer, the third layer, the fourth layer, the fifth layer and the sixth layer at least satisfy a following relational expression:
a thickness of the fifth layer<a thickness of the third layer≤a thickness of the first layer<a thickness of the sixth layer<a thickness of the second layer≤a thickness of the fourth layer.

In the second aspect, a method for coating an anti-reflection film of a metalens is provided by the embodiment of the present disclosure, the method includes:
step 1: filling a gap between the structures with the filler material until the filled metalens has the flat surface; and
step 2: coating the anti-reflection film on the flat surface of the filled metalens.

In the third aspect, a device for designing an anti-reflection film of a metalens is provided by the embodiment of the present disclosure, the device includes: a calculation module and an anti-reflection film optimization module; where,
the calculation module is configured to calculate a refractive index and an extinction coefficient of a filled metalens based on a refractive index of structures, an extinction coefficient of the structures, a refractive index of a filler material and an extinction coefficient of the filler material; the structures are in microscale or nanoscale; and
the anti-reflection film optimization module is configured to calculate a parameter of an initial anti-reflection film based on the refractive index of the filled metalens and the extinction coefficient of the filled metalens, and the anti-reflection film optimization module is also configured to perform an optimization iteration on the parameter of an initial anti-reflection film, so as to obtain an optimized parameter of the anti-reflection film.

Optionally, the anti-reflection film optimization module includes an anti-reflection film calculation module and a finite element analysis module; where,
the anti-reflection film calculation module is configured to calculate the parameter of the initial anti-reflection film;
the finite element analysis module is configured to obtain a light field phase and transmittance based on the parameter of the initial anti-reflection film; and
the anti-reflection film calculation module and the finite element analysis module together perform an optimization iteration on the parameter of the initial anti-reflection film calculated by the anti-reflection film calculation module, so as to obtain an optimized parameter of the anti-reflection film.

In the fourth aspect, an anti-reflection film of a metalens is provided by the embodiment of the present disclosure, includes the anti-reflection film design by any of the above method of designing the anti-reflection film of the metalens.

In the fifth aspect, a metalens is provided by the embodiment of the present disclosure, includes the anti-reflection film design by any of the above method of designing the anti-reflection film of the metalens.

An electronic device is also provided by the embodiment of the present disclosure, includes: a bus, a transceiver, a memory, a processor and a computer program;
the computer program is stored in the memory and executable on the processor;
the transceiver, the memory and the processor are connected through the bus;
the computer program is executed by the processor, so as to implement the method of designing the anti-reflection film of the metalens.

A non-transitory computer-readable storage medium is also provided by the embodiment of the present disclosure, in which a computer program is stored, and the computer program is executed by a processor, so as to implement the method of designing the anti-reflection film of the metalens.

The present disclosure has at least the following beneficial effects: the method of designing an anti-reflection film of a metalens provided by the embodiment of the present disclosure uses the filler material to fill the gaps between the structures of the metalens, so as to flat the surface of the metalens, which solves the problem of changing the phase of incident light through the metalens when the anti-reflection film is deposited. In the method, the effective refractive index and the equivalent extinction coefficient of respective filled unit cells is calculated by the effective refractive index and equivalent extinction coefficient of the filled unit cells consisting of the structure and the filler material, thus the refractive index and the extinction coefficient of the filled metalens can be obtained by calculating a weighted average of the effective refractive index and the equivalent extinction coefficient of the filled unit cells. In this method, the parameter of the initial anti-reflection film is calculated by the refractive index and the extinction coefficient of the filled metalens, and the parameter of the optimized parameter of the anti-reflection film is obtained by optimizing the initial anti-reflection film. The anti-reflection film obtained by the method can increase transmittance of the incident light, while does not affect the structures of the metalens, and has no effect on the modulation of the incident light by the metalens.

### BRIEF DESCRIPTION OF THE DRAWINGS

In order to explain more clearly, the technical scheme in the disclosure technology or the background technology, the attached drawings required in the disclosure embodiment or the background technology will be explained below.

FIG. 1 illustrates a schematic diagram of a metalens provided by the embodiment of the present disclosure.

FIG. 2 illustrates an optional configuration diagram of a coating metalens provided by the embodiment of the present disclosure.

FIG. 3 illustrates a flowchart of a method of designing an anti-reflection film of a metalens provided by the embodiment of the present disclosure.

FIG. 4 illustrates a schematic diagram of filled unit cells provided by the embodiment of the present disclosure.

FIG. 5 illustrates a flowchart of a method of designing an anti-reflection film of a metalens provided in the embodiment of the present disclosure.

FIG. 6 illustrates an optional schematic diagram of a method of designing an anti-reflection film of a metalens provided by the embodiment of the present disclosure.

FIG. 7 illustrates the relationship between the phase and the transmittance of a direct calculation and the incident light wavelength provided in the embodiment of the present disclosure.

FIG. 8 illustrates an optional schematic diagram of a method of designing an anti-reflection film of a metalens provided by the embodiment of the present disclosure.

FIG. 9 illustrates an optional schematic diagram of an anti-reflection film optimization module provided by the embodiment of the present disclosure.

FIG. 10 illustrates a optional arrangement of structures provided by the embodiment of the present disclosure.

FIG. 11 illustrates an effective refractive index of an optional filled unit cells at a wavelength of 0.45 μm as provided by a embodiment of the present disclosure.

FIG. 12 illustrates an equivalent extinction coefficient of an optional filled unit cells at a wavelength of 0.45 μm as provided by a embodiment of the present disclosure.

FIG. 13 illustrates an effective refractive index of an optional filled unit cells at a wavelength of 0.55 μm as provided by a embodiment of the present disclosure.

FIG. 14 illustrates an equivalent extinction coefficient of an optional filled unit cells at a wavelength of 0.55 μm as provided by a embodiment of the present disclosure.

FIG. 15 illustrates an effective refractive index of an optional filled unit cells at a wavelength of 0.65 μm as provided by a embodiment of the present disclosure.

FIG. 16 illustrates an equivalent extinction coefficient of an optional filled unit cells at a wavelength of 0.65 μm as provided by a embodiment of the present disclosure.

FIG. 17 illustrates an optional equivalent refractive index of metalens provided by the embodiment of the present disclosure.

FIG. 18 illustrates an optional equivalent extinction coefficient of metalens provided by the embodiment of the present disclosure.

FIG. 19 illustrates an optional structural schematic diagram of a parameter of an initial anti-reflection film provided by the embodiment of the present disclosure.

FIG. 20 illustrates an optional structural schematic diagram of a parameter of an initial anti-reflection film provided by the embodiment of the present disclosure.

FIG. 21 illustrates the transmittance and phase of a metalens without the optimized anti-reflection film at a wavelength of 0.45 μm.

FIG. 22 illustrates the transmittance and phase of a metalens with the optimized anti-reflection film at a wavelength of 0.45 μm.

FIG. 23 illustrates the transmittance and phase of a metalens without the optimized anti-reflection film at a wavelength of 0.55 μm.

FIG. 24 illustrates the transmittance and phase of a metalens with the optimized anti-reflection film at a wavelength of 0.55 μm.

FIG. 25 illustrates the transmittance and phase of a metalens without the optimized anti-reflection film at a wavelength of 0.65 μm.

FIG. 26 illustrates the transmittance and phase of a metalens with the optimized anti-reflection film at a wavelength of 0.65 μm.

FIG. 27 illustrates an optional schematic diagram of the electronic device provided in the embodiment of the present disclosure.

### DETAILED DESCRIPTION OF DISCLOSED EMBODIMENTS

In the description of the embodiment of the present disclosure, those skilled in the art should know that the embodiment of the present disclosure can be implemented as a method, device, electronic device and a computer-readable storage medium. Therefore, the embodiment of the present disclosure can be specifically implemented in the form of complete hardware, complete software (including firmware, resident software, microcode, etc.), and a combination of hardware and software. Further, in some embodiments, the embodiments of the present disclosure may also be implemented in the form of a computer program product in one or more computer-readable storage media, which contains computer program code.

The above-mentioned computer-readable storage media may use any combination of one or more computer-readable storage media. A computer-readable storage medium includes a system, device or device of electrical, magnetic, optical, electromagnetic, infrared or semiconductor, or any combination of the above. More specific examples of computer-readable storage media include portable computer disks, hard disks, random access memory (RAM), read only memory (ROM), erased programmable read only memory (EPROM), flash memory (Flash Memory), optical fiber, CD read only memory (CD-ROM), optical storage devices, magnetic memory devices or any combination of the above. In embodiments of the present disclosure, a computer-readable storage medium may be a tangible medium arbitrarily containing or storing a program that may be used by or in combination with an instruction execution system, device, or device.

The computer program code contained in the computer-readable storage medium of the above computer may be transmitted with any appropriate medium, including: a wireless, a wire, an optical cable, a Radio Frequency (RF) or any appropriate combination of the above.

Computer program code for embodiment of the present disclosure may be written in assembly instructions, instruction set architecture (ISA) instructions, machine instructions, machine-related instructions, microcodes, firmware instructions, state setting data, integrated circuit configuration data, or in one or more thereof, including an object-oriented programming language such as: Java, Smalltalk, C++, and also a conventional procedural programming language such as: C language or a similar programming language. Computer program code can be completely executed on the user computer, partly on the user computer, as a separate software package, partly on the user computer, partly on the remote computer and fully on the remote computer or server. In cases involving remote computers, a remote computer can be connected to a user computer through any kind of network, including a local area network (LAN) or a wide area network (WAN), or to an external computer.

Embodiments of the present disclosure describe the provided methods, devices, and electronic devices by a flow chart and/or a block diagram.

It should be understood that each block of the flow diagram and/or block diagram and the combination of the blocks in the flow chart and/or block diagram can be implemented by computer-readable program instructions. These computer readable program instructions may be provided to a processor of a general purpose computer, a dedicated computer or other programmable data processing device to produce a computer in which these computer readable program instructions are executed by a computer or other programmable data processing device, producing devices for implementing functions/operations as specified in the flow chart and/or block diagram.

Embodiments of the present disclosure describe the provided methods, devices, and electronic devices by a flow chart and/or a block diagram.

It should be understood that each block of the flow diagram and/or block diagram and the combination of the blocks in the flow chart and/or block diagram can be implemented by computer-readable program instructions. These computer readable program instructions may be provided to a processor of a general purpose computer, a dedicated computer or other programmable data processing device to produce a computer in which these computer readable program instructions are executed by a computer or other programmable data processing device, producing devices for implementing functions/operations as specified in the flow chart and/or block diagram.

These computer-readable program instructions may also be stored in a computer-readable storage medium that enables a computer or other programmable data processing devices to operate in a specific manner. Thus, instructions stored in a computer-readable storage medium produce an instruction device product including the functions/operations specified in the flow chart and/or block diagram.

Computer readable program instructions may also be loaded onto a computer, other programmable data processing device or other equipment, so that a series of operation steps can be performed on a computer, other programmable data processing device or other equipment to generate a computer realized process, allowing instructions executed on a computer or other programmable data processing device to implement the functions/operation specified in the flow chart and, or block diagram.

The embodiment of this disclosure is described below in combination with the accompanying drawings in the embodiment of the present disclosure.

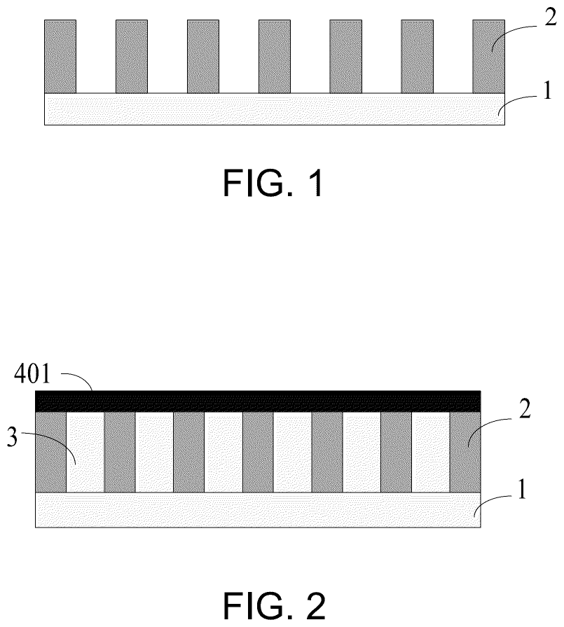

A metalens is a kind of application of a metasurface. As shown in FIG. 1, the metalens includes substrate 1 and structure 2, the structure 2 is used for modulating the phase of incident light. When using the traditional method of designing an anti-reflection film of a metalens for coating, the designed film will be deposited on the structure 2, and will fill into the air gap between the structure 2. Thus the deposited film will change the structure consisting of the structure 2 and air, so as to change the incident light phase and affect the optical performance of the metalens. In addition, due to the existence of the structure on the surface of the metalens, the thickness of the deposited film is uneven and the flatness of metalens is not good, thus the metalens with anti-reflection film is not suitable for mass production.

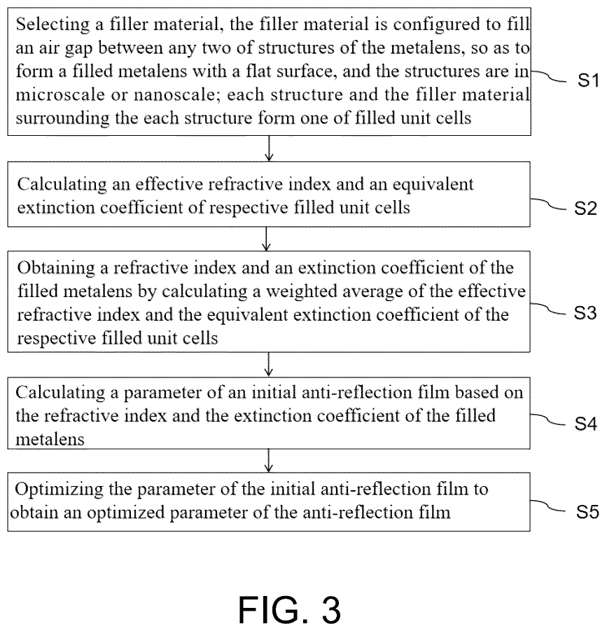

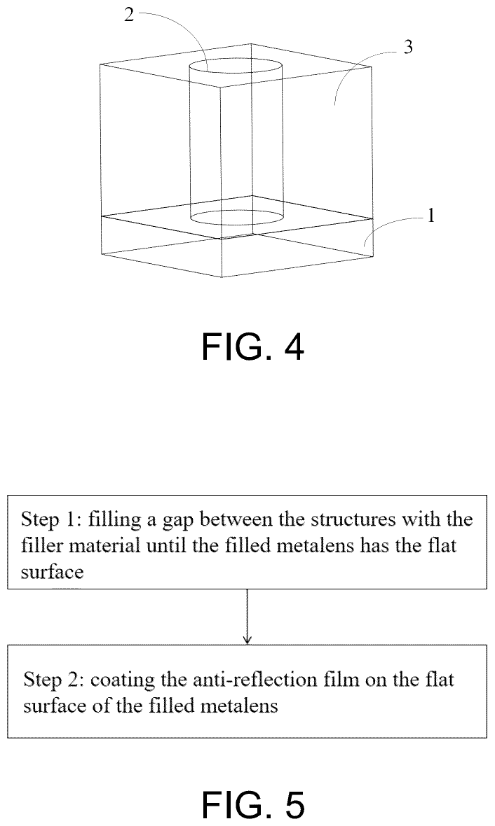

The embodiment of the present disclosure provides the method of designing an anti-reflection film of the metalens. During the design process of the anti-reflection film, the gap between the structures is filled into other materials, and the filler materials and the structures may be equivalent to a flat lens as a entire. FIG. 3 shows a flowchart of method of designing an anti-reflection film of a metalens provided by the embodiment of the present disclosure. As shown in FIG. 2 and FIG. 3, the method including:
step S1: select a filler material 3, and the filler material 3 is configured to fill an air gap between any two of structures 2 of the metalens, so as to form a filled metalens with a flat surface, and the structures 2 are in microscale or nanoscale. In one embodiment, the refractive index of the filler material 3 is much less than that of the structure 2, each structure 2 and the filler material 3 surrounding the each structure 2 form one of filled unit cells, the structure of filled unit cells as shown in FIG. 4.
step S2: calculate an effective refractive index and an equivalent extinction coefficient of 1 respective filled unit cells.
step S3: obtain a refractive index and an extinction coefficient of the filled metalens by calculating a weighted average of the effective refractive index and the equivalent extinction coefficient of the respective filled unit cells. In one embodiment, a weighted coefficient will place emphasis on the structures with low transmittance in some bands, so as to ensure that the entire band has a relatively high and uniform transmittance.
step S4: calculate a parameter of an initial anti-reflection film 401 based on the refractive index and the extinction coefficient of the filled metalens. In one embodiment, the obtained parameter of the initial anti-reflection film 401 includes: a number of the initial anti-reflection layers, a thickness of each initial anti-reflection layer and a material of each initial anti-reflection layer.
step S5: optimize the parameter of the initial anti-reflection film, obtain an optimized parameter of the anti-reflection film 402.

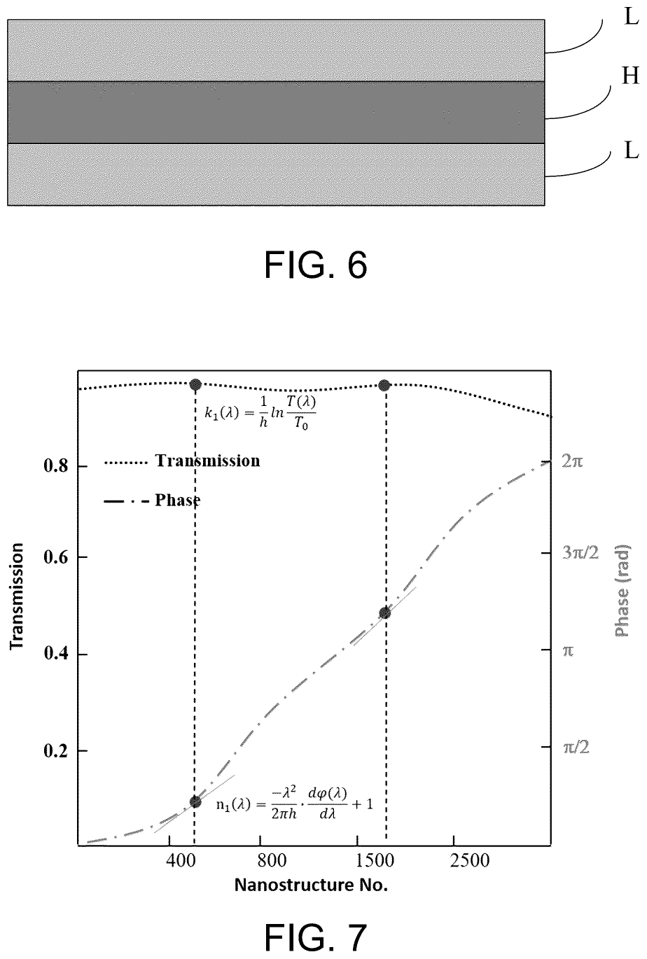

In one embodiment, the parameter of the initial anti-reflection film 401 and the parameter of the optimized of the anti-reflection film 402 may be a single-layered film, or may be a multi-layered film, such as HLH, LHL, LHLH etc as shown in FIG. 6. To be noticed, L represents the anti-reflection film layers with low refractive index and H represents the anti-reflection film layers with high refractive index.

In some embodiments, the materials of the substrate 1 include materials with at least about 20%, 30%, 40%, 50%, 60%, 70%, 80%, 85%, 90% or 95% transmittance on the target band. In one embodiment, materials of the substrate 1 include one or more of materials, suchlike: silicon, silicon oxides, Plexiglas, alkaline glass, and sulfur glass. Optionally, materials of the structures 2 include one or more of materials, suchlike:silicon nitride, titanium oxide, alumina, gallium nitride, gallium-gallium phosphate, hydrogenated amorphous silicon, amorphous silicon and crystalline silicon. In one embodiment, an aspect ratio of structure 2 (for example, the ratio of height to width of the structure 2 or the height to diameter of the structure 2) may be greater than 1, e.g., at least about 1.5:1, at least about 2:1, at least about 3:1, at least about 4:1, at least about 5:1, at least about 6:1, or at least about 10:1. Optionally, the aspect ratio of the structure 2 may be less than or equal to 1.

In one embodiment, the embodiment of the method of designing the anti-reflection film of the metalens provided by the embodiment of the present disclosure as following:
step S1: select alumina (Al₂O₃) as the filler material 3. The alumina has a high transparency, so the alumina is configured to fill air gaps between any two of structures 2 of the metalens, and the structures 2 are in microscale or nanoscale. Each structure 2 and the alumina surrounding the each structure 2 form one of filled unit cells.
step S2: calculate the effective refractive index and the equivalent extinction coefficient of all respective filled unit cells of the entire metalens.
step S3: obtain the effective refractive index and the extinction coefficient of the entire filled metalens by calculating a weighted average of the effective refractive index and the equivalent extinction coefficient of the all respective filled unit cells.
step S4: calculate a parameter of an initial anti-reflection film 401 based on the refractive index and the extinction coefficient of the filled metalens.
step S5: optimize the parameter of the initial anti-reflection film 401, obtain an optimized parameter of the anti-reflection film 402.

In one embodiment, the metalens of the structure 2 with an even array distribution, the design method of the metalens as following:
step S1: select a filler material 3 as alumina (Al₂O₃), and the alumina has a high transparency. The filler material 3 is configured to fill an air gap between any two of structures 2 of the metalens, and the structures 2 are in microscale or nanoscale. Each structure 2 and the alumina surrounding the each structure 2 form one of filled unit cells.
step S2: calculate the effective refractive index and the equivalent extinction coefficient of parts of the filled unit cells. For example, the step S2 may be to calculate the effective refractive index and the equivalent extinction coefficient of 60% of the filled unit cells. For example, the step S2 may be to perform only once calculation for the filled unit cells consisting of structures 2 of with the same structure and the filler material 3 with structures 2 surrounding, rather than perform repeated calculation. For example, the following step is based on the arrangement of the structures 2 of the metalens, to form adjacent filled unit cells into one super-structural unit, then calculating the effective refractive index and the equivalent extinction coefficient of one super-structural unit. Thus, the effective refractive index and the equivalent extinction coefficient of the entire metalens are introduced according to the super-structural unit. In one embodiment, according to the arrangement of the structure 2 on the metalens, the entire metalens is divided by a positive hexagon, and the equivalent refractive index of each positive hexagon is calculated to obtain the effective refractive index of the entire metalens.
step S3: obtain the refractive index and the extinction coefficient of the filled unit cells of the metalens by calculating a weighted average of the effective refractive index and the equivalent extinction coefficient of parts of the respective filled unit cells.
step S4: calculate a parameter of an initial anti-reflection film 401 based on the effective refractive index and the extinction coefficient of the metalens.
step S5: optimize the parameter of the initial anti-reflection film 401, obtain an optimized parameter of the anti-reflection film 402.

It should be understood that in the embodiment of this disclosure, the filler material 3 includes but is not limited to the alumina. The selecting of filler material 3 should be a material with high transmittance to the light in the target band. In the embodiment of the present disclosure, the target band of the metalens includes but is not limited to visible light, near infrared light, medium infrared light, far infrared light, and ultraviolet light.

In the embodiment of the present disclosure, optionally, calculating the effective refractive index and the equivalent extinction coefficient of the respective filled unit cells including:
step S201: calculate the effective refractive index and the equivalent extinction coefficient of the respective filled unit cells by a duty ratio method; or
step S202: obtain the effective refractive index and the equivalent extinction coefficient of the respective filled unit cells by a direct calculation.

In the optional embodiment of the present disclosure, the steps of calculating the effective reflection index and equivalent extinction coefficient of the filled unit cell by the duty ratio method is as following:

The duty ratio method includes: calculating the effective refractive index and equivalent extinction coefficient of the filled unit cells composed of the structure 2 and filler material 3 by the refractive index and extinction coefficient of the structure 2 and the filler material 3, and the proportion of the structure 2 and the filler material 3 of the filled unit cells. The calculation formulas are shown in formulas (1), (2) and (3):

$${n}_{1} ( λ ) = {ρ}^{′} {n}_{u} ( λ ) + {ρ}^{″} {n}_{f} ( λ ) , \qquad ( 1 )$$

$${k}_{1} ( λ ) = {ρ}^{′} {k}_{u} ( λ ) + {ρ}^{″} {k}_{f} ( λ ) , \qquad ( 2 )$$

$${ρ}^{′} + {ρ}^{″} = 1 , \qquad ( 3 )$$

Where, λ represents a wavelength of light; n₁(λ) represents the calculated effective index of the filled unit cells; k₁(λ) represents the calculated equivalent extinction coefficient of the filled unit cells; nᵤ(λ) represents a refractive index of the structures; n_{f}(λ) represents a refractive index of the filler material; kᵤ(λ) represents an extinction coefficient of the structures; k_{f}(λ) represents an extinction coefficient of the filler material; ρ′ represents a ratio of an area of the structures to an area of the respective filled unit cells; and ρ″ represents a ratio of an area of the filler material to the area of the respective filled unit cells.

In one embodiment, the method of designing the anti-reflection film of the metalens of the present disclosure as following:
step S1: select a filler material 3, the filler material 3 is configured to fill an air gap between any two of structures 2 of the metalens, so as to form a filled metalens with a flat surface, and the structures 2 are in microscale or nanoscale, each structure 2 and the filler material 3 surrounding the each structure 2 form one of filled unit cells, the structure of filled unit cells shows in FIG. 4.
step S201: calculate the effective refractive index and the equivalent extinction coefficient of the respective filled unit cells by a duty ratio method. The effective refractive index and equivalent extinction coefficient of the filled unit cells composed of the structure 2 and the filler material 3 is calculated by inputting the refractive index and extinction system of the structure 2 and the filler material 3 respectively, the proportion of the the structure 2 and the filler material 3 of the filled unit cells into the formula (1), formula (2) and formula (3).
step S3: obtain a refractive index and an extinction coefficient of the filled metalens by calculating a weighted average of the effective refractive index and the equivalent extinction coefficient of the filled unit cells. For example, the step S3 may be to calculate the effective refractive index and the equivalent extinction coefficient of the all filled unit cells of the entire metalens. In one embodiment, a weighted coefficient will place emphasis on the partial structures 2 with low transmittance in some bands, so as to ensure the entire band with a high and even transmittance.
step S4: calculate a parameter of an initial anti-reflection film 401 based on the refractive index and the extinction coefficient of the filled metalens. In one embodiment, the obtained parameter of the initial anti-reflection film 401 includes: a number of the initial anti-reflection layers, a thickness of each initial anti-reflection layer and a material of each initial anti-reflection layer.
step S5: optimize the parameter of the initial anti-reflection film 401, obtain an optimized parameter of the anti-reflection film 402.

In the embodiment of the present disclosure, the embodiment of calculating the equivalent refractive index and the equivalent extinction coefficient of the filling unit by the direct calculation method as following:
The phase φ(λ) may be directly calculated by the finite element analysis, and transmittance T(λ) of the filled unit cells at different wavelengths. The curve lines of phase φ(λ) and transmittance T(λ) at different wavelengths obtained by formula (4) and formula (5) are shown in FIG. 7. The n₁(λ) is the refractive index corresponding to any wavelength, and n₁(λ) can be obtained by using the tangent method on the curve line shown as FIG. 7. The k₁(λ) is the extinction coefficient corresponding to any wavelength, and can be directly calculated from the definition of the extinction coefficient. Formula (4) and Formula (5) are as follows:

$${n}_{1} ( λ ) = \frac{- {λ}^{2}}{2 π h} \cdot \frac{d φ ( λ )}{d λ} + 1 , \qquad ( 4 )$$

$${k}_{1} ( λ ) = \frac{1}{h} ln \frac{T ( λ )}{{T}_{0}} , \qquad ( 5 )$$

Where, h represents a height of the structures 2; T0 represents light intensity of incident light, φ(λ) represents a phase of the respective filled unit cells at different wavelengths; and T(λ) represents transmittance of the respective filled unit cells at different wavelengths.

In one embodiment, the method of designing an anti-reflection film of a metalens provided by the embodiment of the present disclosure as following:
step S1: select a filler material 3, and the filler material 3 is configured to fill an air gap between any two of structures 2 of the metalens, so as to form a filled metalens with a flat surface, and the structures 2 are in microscale or nanoscale, each structure 2 and the filler material 3 surrounding the each structure 2 form one of filled unit cells, the structure of filled unit cells shown as FIG. 4.
step S202: calculating the effective refractive index and the equivalent extinction coefficient of the filled unit cell by the direct calculation. The phase φ(λ) and the transmittance T(λ) of the filled unit cell at different wavelengths may be directly calculated by the finite element analysis. The effective refractive index and equivalent extinction coefficient of the filled unit cells composed of the structures 2 and the filler materials 3 are calculated by inputting the phase φ(λ) and the transmittance T(λ) into the formula (4) and formula (5).
step S3: obtain a refractive index and an extinction coefficient of the filled metalens by calculating a weighted average of the effective refractive index and the equivalent extinction coefficient of the respective filled unit cells. For example, the step S3 may be to calculate the effective refractive index and the equivalent extinction coefficient of the all filled unit cells of the filled metalens. In one embodiment, a weighted coefficient will place emphasis on partial structures 2 with low transmittance in some bands, so as to ensure the entire band with a high and even transmittance.
step S4: calculate a parameter of an initial anti-reflection film 401 based on the refractive index and the extinction coefficient of the filled metalens. For example, the obtained parameter of the initial anti-reflection film 401 includes: a number of the initial anti-reflection layers, a thickness of each initial anti-reflection layer and a material of each initial anti-reflection layer.
step S5: optimize the parameter of the initial anti-reflection film 401, obtain an optimized parameter of the anti-reflection film 402.

In an optional embodiment, the method of designing the anti-reflection film of the metalens provided by the embodiment of the disclosure obtains the refractive index and extinction coefficient of the filled metalens based on the weighted average of the effective refractive index and the equivalent extinction coefficient of the filled unit cell, and the formula is as follows:

$$n ( {λ}_{j} ) = {Σ}_{i = 1 , j = 1}^{M \times N} {C}_{ij} {n}_{i} ( {λ}_{j} ) , \qquad ( 6 )$$

$$k ( {λ}_{j} ) = {Σ}_{i = 1 , j = 1}^{M \times N} {C}_{ij} {k}_{i} ( {λ}_{j} ) , \qquad ( 7 )$$

Where, c represents a weighting coefficient; M represents all the filled unit cells in the entire metalens; N represents a number of selected wavelengths; n(λ) represents the effective refractive index; and k(λ) represents the equivalent extinction coefficient.

In one embodiment, the weighted coefficient c may place emphasis on the partial structure 2 with low transmittance in some bands, so as to ensure the entire band with a high and even transmittance.

In an optional embodiment, the method of designing the anti-reflection film of the metalens provided by the embodiment of the disclosure calculates the initial anti-reflection film 401 based on the refractive index and extinction coefficient of the entire metalens obtained by weighted average in step S3.

In one embodiment, the initial anti-reflection film 401 is calculated by using a software of designing the anti-reflection film (such as TFCalc). In one embodiment, the obtained parameter of the initial anti-reflection film 401 includes: a number of the initial anti-reflection layers, a thickness of each initial anti-reflection layer and a material of each initial anti-reflection layer.

In an optional embodiment, the method of designing the anti-reflection film of the metalens provided by the embodiment of the disclosure optimizes the parameter of the initial anti-reflection film 401, and obtains an optimized parameter of the anti-reflection film 402. The optimization process including:
step S501: analyze the parameter of the initial anti-reflection film 401 by the finite element analysis, so as to obtain an initial light field phase and initial transmittance of the metalens having the initial anti-reflection film.
step S502: perform an optimization iteration based on the initial light field phase and the initial transmittance, so as to obtain the optimized parameter of the anti-reflection film 402.

Optionally, the optimization iteration comprises an interior point method, a steepest descent method and a Newton's method.

In one embodiment, the method of designing the anti-reflection film of the metalens including:
step S1: select alumina (Al₂O₃) as the filler material 3. The alumina has a high transparency, so the alumina is configured to fill air gaps between any two of structures 2 of the metalens, and the structures 2 are in microscale or nanoscale. Each structure 2 and the alumina surrounding the each structure 2 form one filled unit cell.
step S201: calculate the effective refractive index and the equivalent extinction coefficient of the filled unit cells by the duty ratio method.
step S3: obtain the refractive index and an extinction coefficient of the entire filled metalens by calculating a weighted average of the effective refractive index and the equivalent extinction coefficient of all the filled unit cells.
step S4: calculate a parameter of an initial anti-reflection film 401 based on the refractive index and the extinction coefficient of the filled metalens. The obtained parameter of the initial anti-reflection film 401 includes: a number of the initial anti-reflection layers, a thickness of each initial anti-reflection layer and a material of each initial anti-reflection layer.
step S501, analyze the parameter of the initial anti-reflection film 401 by the finite element analysis, so as to obtain an initial light field phase and initial transmittance of the metalens having the initial anti-reflection film.
step S502, perform an optimization iteration based on the initial light field phase and the initial transmittance, so as to obtain the optimized parameter of the anti-reflection film 402.

In one embodiment, the method of designing the anti-reflection film of the metalens including:
step S1: select alumina (Al₂O₃) as the filler material 3. The alumina has a high transparency, so the alumina is configured to fill air gaps between any two of structures 2 of the metalens, and the structures 2 are in microscale or nanoscale. Each structure 2 and the alumina surrounding the each structure 2 form one filled unit cell.
step S202: obtain the effective refractive index and the equivalent extinction coefficient of the respective filled unit cells by a direct calculation.
step S3: obtain the refractive index and an extinction coefficient of the entire filled metalens by calculating a weighted average of the effective refractive index and the equivalent extinction coefficient of all the filled unit cells.
step S4: calculate a parameter of an initial anti-reflection film 401 based on the refractive index and the extinction coefficient of the filled metalens. The obtained parameter of the initial anti-reflection film 401 includes a number of the initial anti-reflection layers, a thickness of each initial anti-reflection layer and a material of each initial anti-reflection layer.
step S501, analyze the parameter of the initial anti-reflection film 401 by the finite element analysis, so as to obtain an initial light field phase and initial transmittance of the metalens having the initial anti-reflection film.
step S502, perform the optimization iteration based on the initial light field phase and the initial transmittance, for example, perform the optimization iteration by the Newton's method, so as to obtain the optimized parameter of the anti-reflection film 402.

It should be understood that the embodiment of this present disclosure only describes the filler material 3 as alumina, but the embodiment of this present disclosure is not limited to this, for example, the filling material 3 may also be gallium nitride.

In conclusion, the method of designing the anti-reflection film of the metalens of the embodiment of this disclosure fills the gap between the structures of the metalens and flat the filler material, which solves the problem of changing the phase of incident light of the metalens when the anti-lens film is deposited. The effective refractive index and the equivalent extinction coefficient of respective filled unit cells is calculated by the effective refractive index and equivalent extinction coefficient of the filled unit cells consisting of the structure and the filler material, thus the refractive index and the extinction coefficient of the filled metalens can be obtained by calculating a weighted average of the effective refractive index and the equivalent extinction coefficient of the filled unit cells. In this method, the parameter of the initial anti-reflection film is calculated by the refractive index and the extinction coefficient of the filled metalens, and the parameter of the optimized parameter of the anti-reflection film is obtained by optimizing the initial anti-reflection film. The anti-reflection film obtained by the method can increase the transmittance of incidence light, while does not affect the structure of the metalens, and has no effect on the function of modulation of the incident light of the metalens.

The embodiment of the present disclosure also provides a coating method of an anti-reflection film of a metalens, and the anti-reflection film is designed by the designing method of any of the above embodiment, as shown in FIG. 5, the coating method of the anti-reflection film including:
Step 1: fill a gap between the structures 2 with the filler material 3 until the filled metalens has the flat surface.
Step 2: coat the anti-reflection film on the flat surface of the filled metalens.

In one embodiment, the method for coating an anti-reflection film of a metalens provided by the present embodiment is as follows:
Step 1: fill a gap between the structures 2 with the filler material 3 until the filled metalens has the flat surface.
Step 2: coat the anti-reflection film on the flat surface of the filled metalens according to the parameter of the anti-reflection film obtained from the method of designing the anti-reflection film of a metalens.

Optionally, the coating method of the anti-reflection film is the thermal evaporation.

Optionally, the anti-reflection film may be a single-layered film, or may be a multi-layered film.

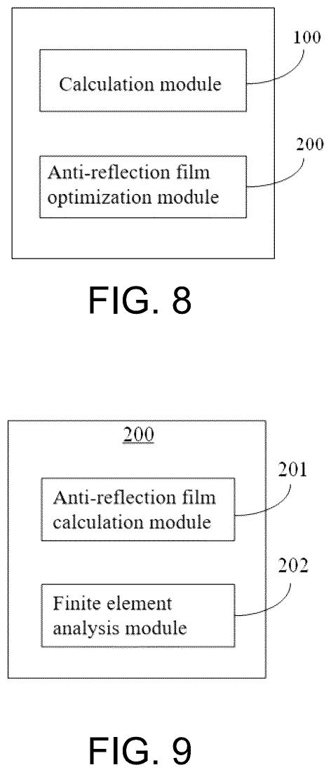

In connection with FIG. 3 to FIG. 7, the method of designing the anti-reflection film of a metalens is described in detail by the embodiment in this disclosure. The method can also be utilized by a corresponding device. The device for designing the anti-reflection film of the metalens provided by the embodiment in this disclosure will be described in detail in combination with FIG. 8 and FIG. 9.

FIG. 8 illustrates a schematic view of the device for designing the anti-reflection film of the metalens provided by the embodiment of the present disclosure. As shown in FIG. 8, the device for designing the anti-reflection film of the metalens includes a calculation module 100 and an anti-reflection film optimization module 200.

The calculation module 100 is configured to calculate a refractive index and an extinction coefficient of a filled metalens based on a refractive index of structures 2, an extinction coefficient of the structures 2, a refractive index of a filler material 3 and an extinction coefficient of the filler material 3; and the structures are in microscale or nanoscale. And the anti-reflection film optimization module 200 is configured to calculate a parameter of an initial anti-reflection film 401 based on the refractive index of the filled metalens and the extinction coefficient of the filled metalens, and the anti-reflection film optimization module 200 is also configured to perform an optimization iteration on the parameter of an initial anti-reflection film 401, so as to obtain an optimized parameter of the anti-reflection film 402.

FIG. 9 illustrates a schematic view of the anti-reflection film optimization module 200 provided by the embodiment of the present disclosure. As shown in FIG. 9, the anti-reflection film optimization module 200 includes an anti-reflection film calculation module 201 and a finite element analysis module 202.

The anti-reflection film calculation module 201 is configured to calculate the parameter of the initial anti-reflection film; the finite element analysis module 202 is configured to obtain a light field phase and transmittance based on the parameter of the initial anti-reflection film 401; and the anti-reflection film calculation module 201 and the finite element analysis module 202 together perform an optimization iteration on the parameter of the initial anti-reflection film 401 calculated by the anti-reflection film calculation module 201, so as to obtain an optimized parameter of the anti-reflection film 402.

Therefore, the calculation module of the device for designing the anti-reflection film of the metalens provided by the embodiment in this disclosure calculates refractive index and extinction coefficients of the filled metalens based on the refractive index and extinction coefficient of the structures and filler materials. The anti-reflection film optimization module of the device calculates the the parameter of initial anti-reflection film based on the refractive index and extinction coefficients of the filled metalens, and obtains an optimized parameter of the anti-reflection film by optimization iteration of the the parameter of initial anti-reflection film.

The embodiment of the present disclosure also provides anti-reflection film of a metalens, using the method of designing the anti-reflection film of the metalens and the device for designing an anti-reflection film of a metalens of any of the above embodiment, the anti-reflection film is coated on the surface of the metalens; and the metalens includes a substrate 1, structures 2 and filler material 3; the anti-reflection film 401 may include a single-layered film, or a multi-layered film.

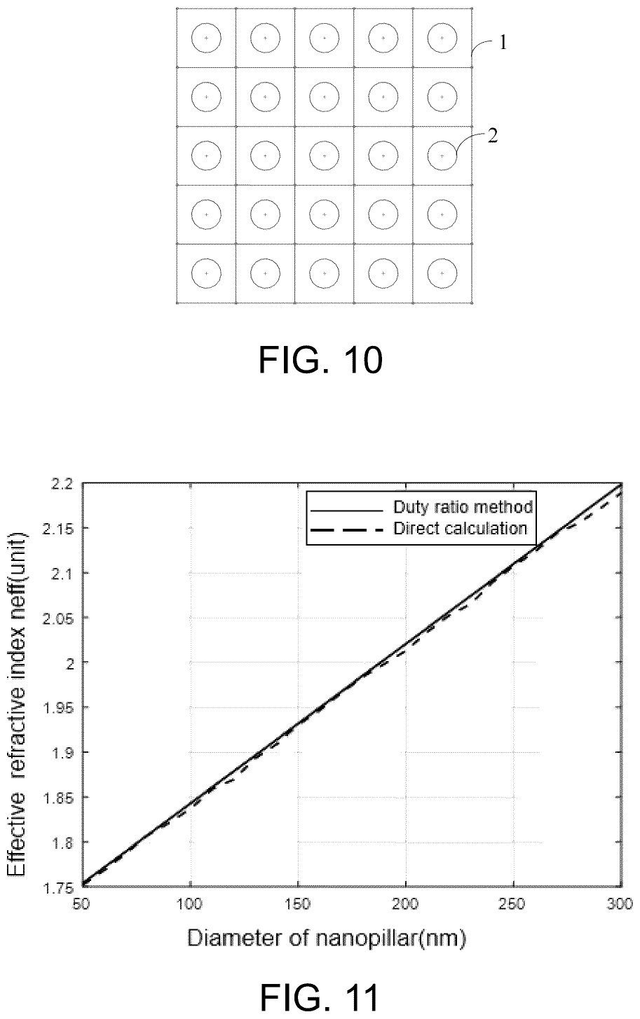

In one embodiment, the working wavelength band of the the anti-reflection film of the metalens is 450 nm-650 nm, and the material, the refractive index n and the extinction coefficient k of the substrate 1, the structure 2 and the filler material 3 are shown in Table 1. The shape of the structure 2 is cylindrical with a height of 500 nm. As shown in FIG. 10, the structure 2 is arranged on the substrate 1 in a quadrangle array.

TABLE 1

| | | Rerefractive index n at different | | | The extinction coefficient k at | | |
|---|---|---|---|---|---|---|---|
| | | wavelengths (nm) | | | the different wavelength (nm) | | |
| | Material | 450 | 550 | 650 | 450 | 550 | 650 |
| Substrate 1 | Fused | 1.4656 | 1.4599 | 1.4565 | ≈0 | ≈0 | ≈0 |
| | Silica | | | | | | |
| Structure 2 | TiO₂ | 2.2478 | 2.1644 | 2.1251 | ≈0 | ≈0 | ≈0 |
| Filler | Al₂O₃ | 1.7540 | 1.7530 | 1.7510 | 0.021 | 0.021 | 0.02 |
| material 3 | | | | | | | |

According to step S1 and Table 1, the materials of the substrate 1 and the structure 2 are Fused Silica and titanium oxide (TiO2) respectively, and the material of filler material 3 is alumina (Al₂O₃).

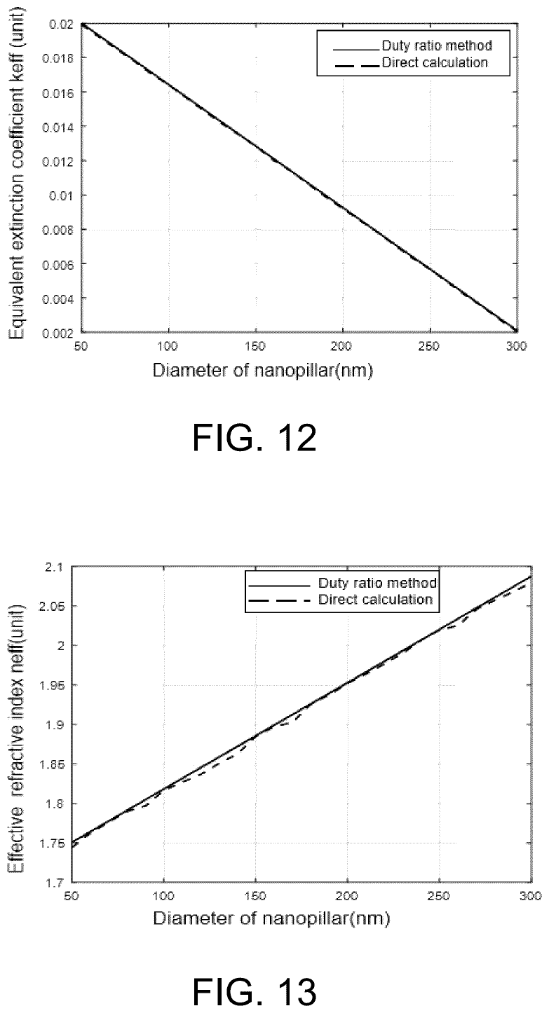

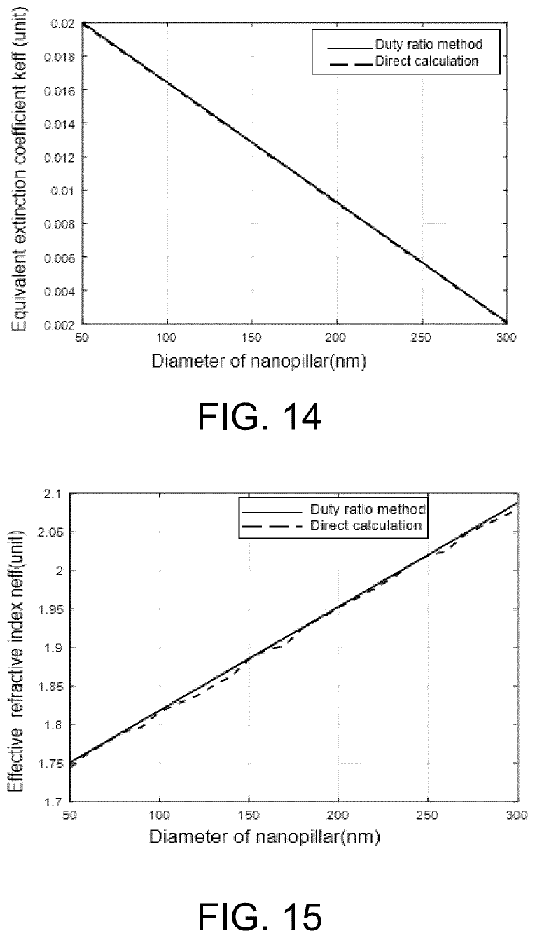

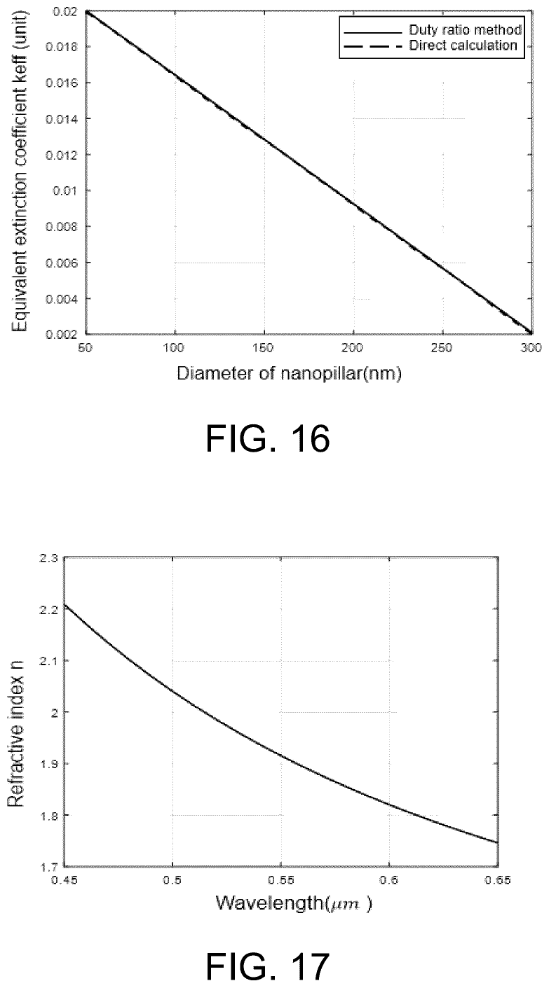

According to step S2, the effective refractive index (neff) and equivalent extinction coefficient (keff) of the filled unit cells composed of the substrate 1, the structure 2 and the filler material 3 at different wavelengths are calculated by a duty ratio method or a direct calculation method. The calculation results are shown in FIGS. 11 to 16. FIG. 11 and FIG. 12 show the effective refractive index and the equivalent extinction coefficient of the filled unit cells at 450 nm, respectively. FIGS. 13 and 14 show the effective refractive index and the equivalent extinction coefficients of the filled unit cells at 550 nm, respectively. FIGS. 15 and 16 show the effective refractive index and the equivalent extinction coefficient of the filled unit cells at 650 nm, respectively.

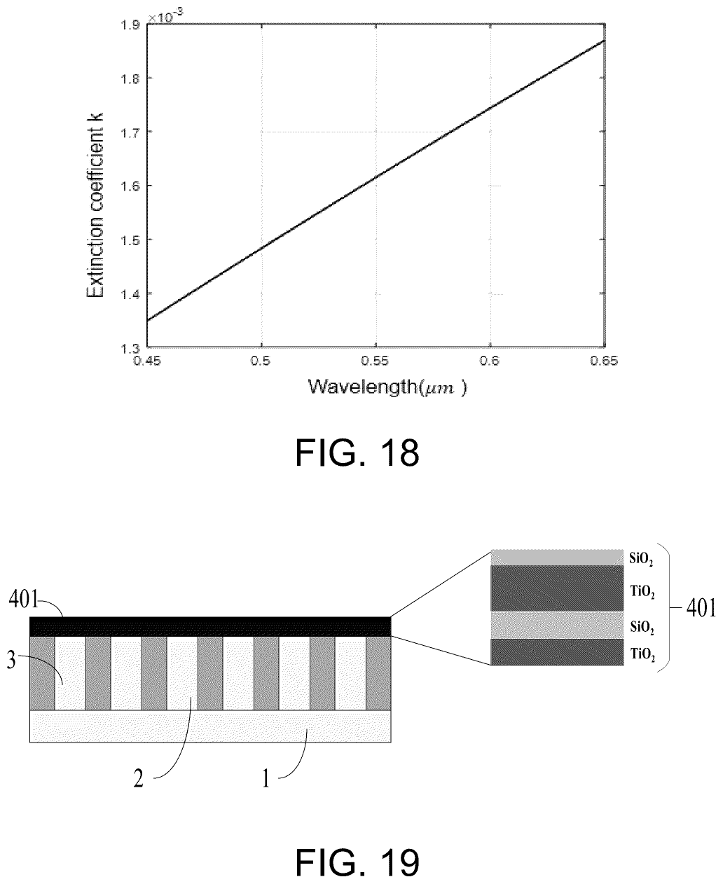

According to step S3, a metalens design is based on the results shown in FIGS. 11 to 16. The designed metalens has a focal length of 20 μm and a diameter of 50 μm. The structure 2 is a nano-cylinder with a height of 500 nm, and the structure 2 is periodicity with 300 nm. The refractive index and extinction coefficients of the entire metalens are shown in FIGS. 17 and 18.

According to step S4, the initial anti-reflection film 401 is calculated based on the refractive index and extinction coefficients of the metalens shown in FIGS. 17 and 18. The initial number of layers of the anti-reflection film 401 is four, and the materials away from the metasurface are titanium oxide (TiO2), silicon oxide (SiO2), titanium oxide (TiO2), silicon oxide (SiO2) in turn. In one embodiment, as shown in FIG. 19, the initial anti-reflection film includes a first layer, a second layer, a third layer and a fourth layer sequentially arranged, and the first layer is closest to the metasurface, the fourth layer is farthest from the metasurface. The first layer, the second layer, the third layer and the fourth layer at least satisfy a following relational expression: a thickness of the fourth layer<a thickness of the first layer≤a thickness of the second layer<a thickness of the third layer.

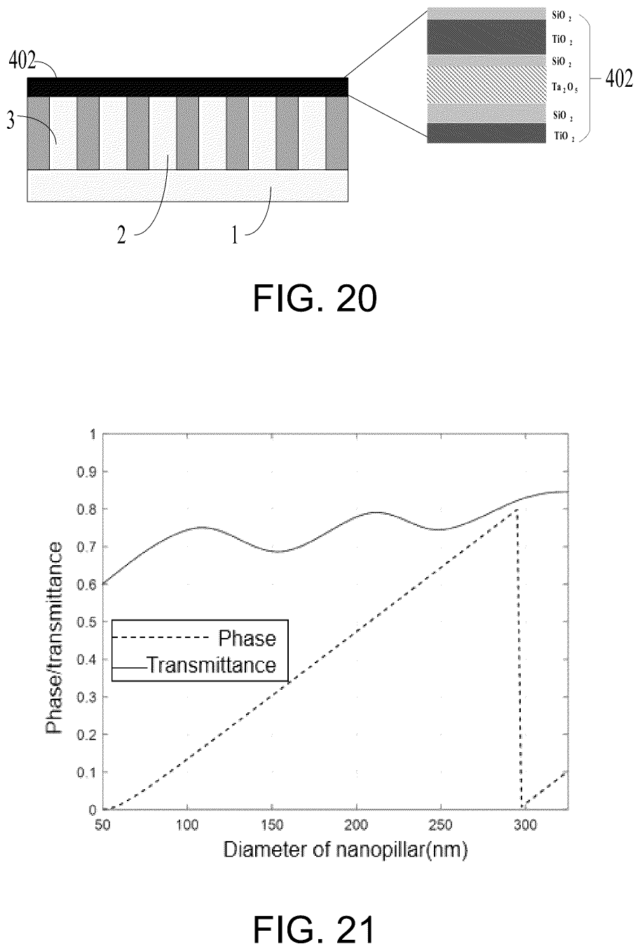

According to step S5, as shown in FIG. 20, optimizing the parameter of the initial anti-reflection film 401 obtains an optimized anti-reflection film 402. The optimized number of layers of the anti-reflection film is six. The optimized anti-reflection film includes a first layer, a second layer, a third layer, a fourth layer, a fifth layer and a sixth layer sequentially arranged, the first layer is closest to the metasurface, the sixth layer is farthest from the metasurface. And a material of the first layer and a material of the fifth layer are titanium oxide; a material of the second layer, a material of the fourth layer and a material of the sixth layer are silicon oxide; and a material of the third layer is thallium oxide. In one embodiment, the first layer, the second layer, the third layer, the fourth layer, the fifth layer and the sixth layer at least satisfy a following relational expression: a thickness of the fifth layer<a thickness of the third layer≤a thickness of the first layer<a thickness of the sixth layer<a thickness of the second layer≤a thickness of the fourth layer.

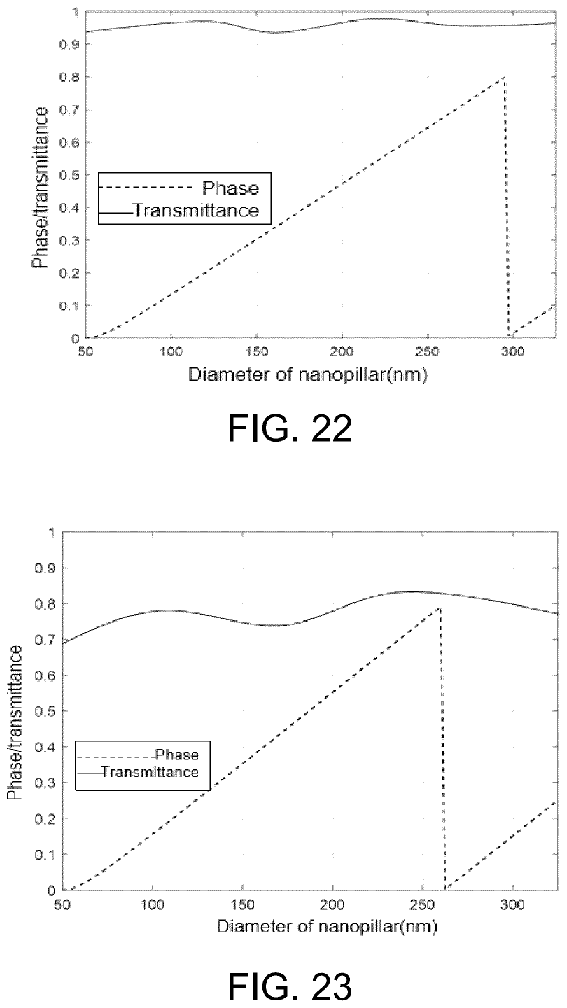

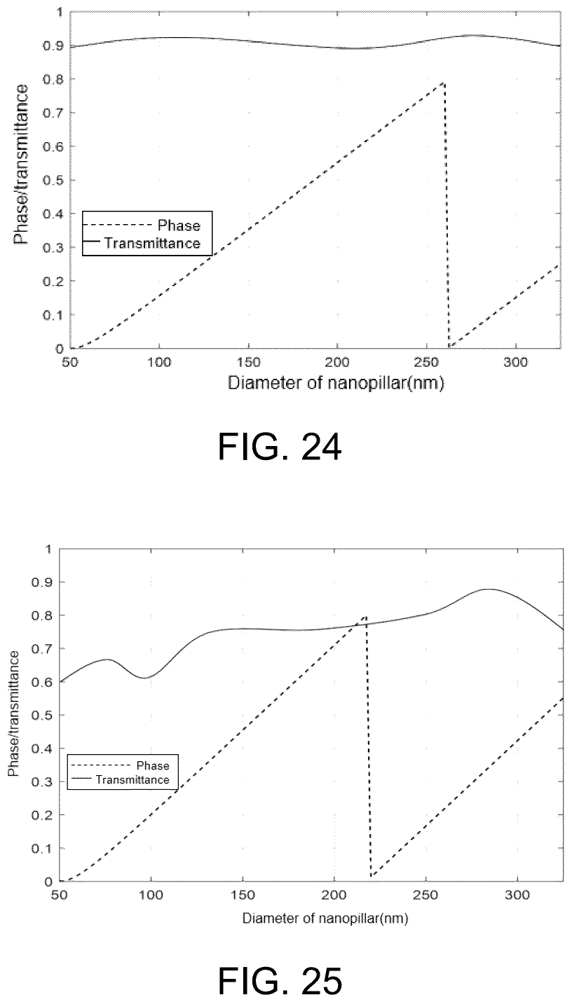

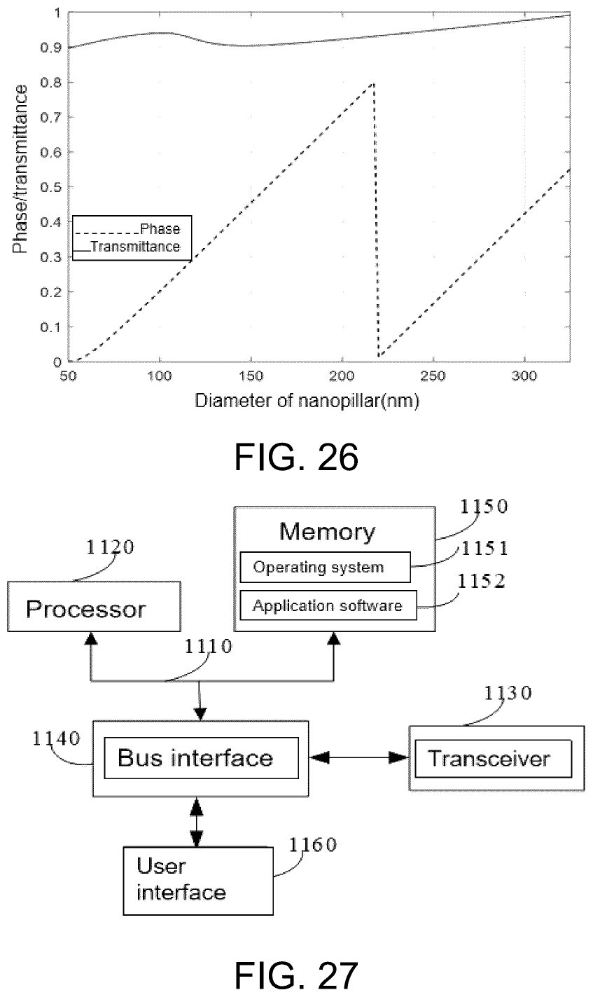

The optimized anti-reflection film 402 increases the transmittance of the incident light but does not affect the phase of the metalens. In one embodiment, the metalens may be set contrast tests in the situation with or without the optimized anti-reflection film 402, so as to compare the phase and transmittance of the metalens, the results of the tests as shown in FIG. 21 to FIG. 26. The optimized anti-reflection film 402 provided by the embodiment of this disclosure can increase the transmittance of the incident light without changing the phase of the metalens. FIGS. 21 and 22 show the phase and transmittance at 450 nm with or without the optimized anti-reflection film on the metalens, respectively. FIGS. 23 and 24 show the phase and transmittance at 550 nm with or without the optimized anti-reflection film on the metalens, respectively. According to FIG. 21 to FIG. 26, the optimized anti-reflection film provided by the present disclosure embodiment increases the transmittance of the incident light.

In conclusion, in the method of designing and device of the anti-reflection film of the metalens provided by the present disclosure, the effective refractive index and extinction coefficient of the metalens are calculated by the effective refractive index and extinction coefficient of the filled unit cells. And then the parameter of the initial anti-reflection film is obtained by the effective refractive index and extinction coefficient of the metalens. The parameter of optimized anti-reflection film is obtained by optimizing the parameter of the initial anti-reflection film, thus the optimized anti-reflection film can avoid the phase changing of the metalens as the anti-reflection film deposits the gaps between the structures. The parameter of optimized anti-reflection film improves the transmittance of the incident light, while does not change the phase of the metalens.

Furthermore, the embodiment of the present disclosure also provides an electronic device, which includes: a bus, a transceiver, a memory, a processor and a computer program, and the computer program is stored in the memory and executable on the processor; the transceiver, the memory and the processor are connected through the bus; the computer program is executed by the processor, so as to implement the steps of the embodiments of the method of designing the anti-reflection film of the metalens, and the electronic device can achieve the same technical effect, in order to avoid repetition, it will not be repeated here.

In one embodiment, referring to FIG. 27, the embodiment of this disclosure also provides an electronic device including a bus 1110, a processor 1120, a transceiver 1130, a bus interface 1140, a memory 1150, and a user interface 1160.

In the embodiment of the present disclosure, the electronic device also includes a computer program stored on the memory 1150 and the computer program can be operated on the processor 1120. The computer program implements the following steps when the computer program is executed by the processor 1120:
step S2, calculate the effective refractive index and the equivalent extinction coefficient of the filled unit cells.
step S3: obtain the refractive index and the extinction coefficient of the filled metalens by calculating a weighted average of the effective refractive index and the equivalent extinction coefficient of the filled unit cells.
step S4: calculate a parameter of an initial anti-reflection film 401 based on the refractive index and the extinction coefficient of the filled metalens. In one embodiment, the parameter of the anti-reflection film includes the number of layers, the thicknesses of each layers and the materials of each layers.
step S5: optimize the parameter of the initial anti-reflection film 401 to obtain an optimized parameter of the anti-reflection film 402.

The transceiver 1130 is used for receiving and transmitting data under the control of the processor 1120.

In the embodiment of the present disclosure, a bus framework (represented by the bus 1110), the bus 1110 any number of interconnected buses and bridges. The bus 1110 is configured to connect various circuits of one or more processors represented by the processor 1120 and a memory represented by the memory 1150.

The bus 1110 represents one or more of any one of a plurality of types of bus structures. The bus 1110 includes a memory bus and a local bus of any structure in a memory controller, a peripheral bus, an Accelerate Graphical Port (AGP), a processor or an architecture using various buses. For the purpose of illustration rather than limitation, the architecture includes an Industry Standard Architecture (ISA) bus, a Micro Channel Architecture (MCA) bus, an Enhanced ISA (EISA) bus, a Video Electronics Standards Association (VESA) bus, a Peripheral Component Interconnect (PCI) bus.

The processor 1120 may be an integrated circuit chip with signal processing capabilities. During the implementation processes, respective steps of the method described in the above embodiments may be completed by instructions in the form of integrated logic circuits in hardware or software in the processor. The processor may be a general-purpose processor, a Central Processing Unit (CPU), a Network Processor (NP), a Digital Signal Processor (DSP), an Application Specific Integrated Circuit (ASIC), a Field Programmable Gate Array (FPGA), a Complex Programmable Logic Device (CPLD), a Programmable Logic Array (PLA), a Microcontroller Unit (MCU) or other equipment such as a programmable logic device, a discrete gate, a transistor logic device, a discrete hardware component, which are capable of implementing or executing the method, respective steps and logical block diagrams disclosed in the present embodiment. For example, the processor may be a single-core processor or a multi-core processor. The processor may be integrated into a single chip or located on multiple different chips.

The processor 1120 may be a microprocessor or any conventional processor. The steps of the method disclosed in the present embodiment may be directly executed by a hardware decoding processor, or may be executed by a combination of a hardware module and a software module in a decoding processor. The software module may be provided in a readable storage media including Random Access Memory (RAM), Flash Memory (Flash Memory), Read-Only Memory (ROM), Programmable Read-Only Memory (PROM), Erasable PROM (EPROM) and a register, which are known in the art. The readable storage medium is located in the memory. The processor reads information in the memory and completes the steps of the method in combination with the hardware of the processor.

The bus 1110 may also realize the circuit connection of other devices such as peripheral equipment, a voltage regulator or power management circuit. The bus interface 1140 provides an interface between the bus 1110 and the transceiver 1130, which are known in the art. The general knowledge will not be described herein.

The transceiver 1130 may be an element or may be multiple elements, such as multiple receivers and multiple transmitters. The transceiver 1130 is configured to serve as a unit for communicating with various other devices over a transmission medium. For example, the transceiver 1130 receives external data from other devices, and the transceiver 1130 is used to send the processed data by the processor 1120 to other devices. Depending on the type of the computer system, a user interface 1160 may also be provided. The user interface 1160 may be a touch screen, a physical keyboard, a monitor, a mouse, a speaker, a microphone, a trackball, a joystick or a stylus.

It should be understood that in the present embodiment, the memory 1150 may further include memories remotely located relative to the processor 1120. The memories may be connected to a server through a network. One or more parts of the network may be an ad hoc network, an intranet, an extranet, a virtual private network (VPN), a local area network (LAN), a wireless local area network (WLAN), a wide area network (WAN), a wireless wide area network (WWAN), a metropolitan area network (MAN), Internet, a public switched telephone network (PSTN), a plain old telephone service (POTS) network, a cellular telephone network, a wireless network, a wireless fidelity (Wi-Fi) network or a combination thereof. The combination includes at least two kinds of networks listed herein. For example, the cellular telephone network and the wireless network may be a Global System for Mobile Communications (GSM), Code Division Multiple Access (CDMA), Worldwide Interoperability for Microwave Access (WiMAX), General Packet Radio Service (GPRS), a Broadband CDMA (WCDMA) system, a Long Term Evolution (LTE) system, an LTE Frequency Division Duplex (FDD) system, an LTE Time Division Duplex (TDD) system, a Long Term Evolution Advanced (LTE-A) system, a Universal Mobile Telecommunications (UMTS) system, an Enhanced Mobile Broadband (eMBB) system, a massive Machine Type of Communication (mMTC) system, an Ultra Reliable Low Latency Communications (uRLLC) system, etc.

It should be understood that the memory 1150 in the present embodiment may be a volatile memory, a non-volatile memory, or a combination thereof. Where, the non-volatile memory may be a Read-Only Memory (ROM), a Programmable ROM (PROM), and an Erasable PROM (EPROM), an Electrically EPROM (EEPROM) or a Flash Memory.

The Volatile memory may be a Random Access Memory (RAM), which is used as an external cache. The RAM may be of various types. For the purpose of illustration but not limitation, the RAM may be a Static RAM (SRAM), a Dynamic RAM (DRAM), a Synchronous DRAM (SDRAM), a Double Data Rate SDRAM (DDRSDRAM), an Enhanced SDRAM (ESDRAM), a synchronous link DRAM (SLDRAM) or a Direct Rambus RAM (DRRAM). The memory 1150 described in the present embodiment may be any of memories listed herein or may be any of other appropriate memories, and the present embodiment is not limited thereto.

In the embodiment of the present disclosure, the memory 1150 stores the following elements of an operating system 1151 and an application program 1152, including an executable module and a data structure, a subset of the operating system 1151 and the application program 1152 or an extended set of the operating system 1151 and the application program 1152.

Specifically, the operating system 1151 includes a variety of system programs including a framework layer, a core library layer and a driver layer, which are used to implement various basic services and process hardware-based tasks. The application program 1152 includes a variety of application programs including a Media Player and a Browser, which are used to implement various application services. Programs of implementing the method of the embodiments of the present disclosure may be included in the application program 1152. The application program 1152 includes applets, objects, components, logic, data structures, and other computer-executable instructions that perform specific tasks or implement specific abstract data types.

Furthermore, the embodiment of this disclosure also provides a non-transitory computer-readable storage medium in which a computer program is stored, and the computer program is executed by a processor, so as to implement the method of designing the anti-reflection film of the metalens, the computer program when executed by the processor can achieve the same technical effect, to avoid duplication, it will not be repeated here.

In one embodiment, the following steps are implemented when the computer program is executed by the processor:
step S2: calculates an effective refractive index and an equivalent extinction coefficient of respective filled unit cells.
step S3: obtains a refractive index and an extinction coefficient of the filled metalens by calculating a weighted average of the effective refractive index and the equivalent extinction coefficient of the respective filled unit cells.
step S4: calculates a parameter of an initial anti-reflection film 401 based on the refractive index and the extinction coefficient of the filled metalens.
step S5: optimizes the parameter of the initial anti-reflection film 401 to obtain an optimized parameter of the anti-reflection film 402.

The computer-readable storage medium includes a media that is permanent (non-transitory), non-permanent, removable or non-removable. The media is a tangible device being capable of reserving and storing instructions which are usable to an instruction execution device. The computer-readable storage medium may be an electronic storage device, a magnetic storage device, an optical storage device, an electromagnetic storage device, a semiconductor storage device, or a combination thereof. The computer-readable storage medium includes a phase-change random access memory (PRAM), a static random access memory (SRAM), a dynamic random access memory (DRAM), other types of random access memory (RAM), a read only memory (ROM), a Non-volatile random access memory (NVRAM), an electrically erasable programmable read-only memory (EEPROM), a flash memory or other memory techniques, a compact disc read-only memory (CD-ROM), a digital versatile disc (DVD) or other optical storage devices, a magnetic cassette storage device, a tape disk storage device or other magnetic storage devices, a memory stick, a mechanical encoding device (such as punched cards or raised structures in grooves in which instructions are recorded) or any other Non-transmission media, which are used to store information that is accessible by a computing device. According to the definition in the present embodiment, the computer-readable storage medium does not include a transient signal itself. The transient signal may be, for example, radio waves or other freely propagating electromagnetic waves, electromagnetic waves propagating through waveguides or other transmission media (such as light pulses passing through fiber optic cables) or an electrical signal transmitted through a wire.

In several embodiments provided in the present disclosure, it should be understood that the disclosed devices, electronic devices, and methods may be implemented in other ways. For example, the device embodiment described above is merely schematic, for example, the division of the module or unit is only a logical function division, which may be actually implemented, such as a plurality of units or components can be combined or integrated into another system, or some features can be ignored or not executed. Further, the coupling or direct coupling or communication connection between each other shown or discussed may be indirect coupling or communication connection through some interfaces, devices or units, or may be electrical, mechanical or other form connection.

The units described as separate components may or may not be physically separated. The components in the form of units may or may not be physical units, which may be located at one location or may be distributed to multiple network units. Some or all of the units may be selected according to actual needs to solve problems in the embodiments of the present disclosure.

In addition, respective functional units in the embodiments of the present disclosure may be integrated into one processing unit, or may be physical existences that are independent, or two or more units may be integrated into one unit. The integrated unit may be implemented in the form of hardware or software functional units.

The integrated unit may be stored in a computer-readable storage medium when the integrated unit is implemented in the form of software functional units, and is sold or used as an independent product. Based on this understanding, core parts of technical solutions or parts of the technical solutions that contribute to the prior art, or all or a part of the technical solutions of the embodiments of the present disclosure may be embodied in the form of a computer software product. The computer software product is stored in a storage medium and the computer software product includes a plurality of instructions. The plurality of instructions are configured to cause a computer device to execute all or a part of steps of the method described in the embodiments of the present disclosure, where the computer device may be a personal computer, a server, a data center or other network devices. The storage medium may be any of aforementioned mediums being capable of storing program code.

The above is only a specific embodiment of the embodiment of this application, but the scope of protection of the embodiment of this disclosure is not limited to this, any person familiar with the scope of the change or substitution, should be covered within the protection scope of the embodiment of this application. Therefore, the scope of the protection of the present disclosure shall depend to the scope of the claims.

What is claimed is:

1. A method of designing an anti-reflection film of a metalens, comprising:
step S1: selecting a filler material, wherein the filler material is configured to fill an air gap between any two of structures of the metalens, so as to form a filled metalens with a flat surface, and the structures are in microscale or nanoscale; each structure and the filler material surrounding the each structure form one of filled unit cells;
step S2: calculating an effective refractive index and an equivalent extinction coefficient of respective filled unit cells;
step S3: obtaining a refractive index and an extinction coefficient of the filled metalens by calculating a weighted average of the effective refractive index and the equivalent extinction coefficient of the respective filled unit cells;
step S4: calculating a parameter of an initial anti-reflection film based on the refractive index and the extinction coefficient of the filled metalens;
step S5: optimizing the parameter of the initial anti-reflection film to obtain an optimized parameter of the anti-reflection film.

2. The method according to claim 1, wherein a step of “calculating the effective refractive index and the equivalent extinction coefficient of the respective filled unit cells” comprises:
step S201: calculating the effective refractive index and the equivalent extinction coefficient of the respective filled unit cells by a duty ratio method; or
step S202: obtaining the effective refractive index and the equivalent extinction coefficient of the respective filled unit cells by a direct calculation.

3. The method of claim 1, wherein a step of “optimizing the parameter of the initial anti-reflection film to obtain the optimized parameter of the anti-reflection film” comprises:
step S501: analyzing the parameter of the initial anti-reflection film by a finite element analysis, so as to obtain an initial light field phase and initial transmittance of the metalens having the initial anti-reflection film;
step S502: performing an optimization iteration based on the initial light field phase and the initial transmittance, so as to obtain the optimized parameter of the anti-reflection film.

4. The method according to claim 2, wherein a step of “calculating the effective refractive index and the equivalent extinction coefficient by the duty ratio method” comprises:
calculating the effective refractive index and the equivalent extinction coefficient by following formulae:
$${n}_{1} ( λ ) = {ρ}^{′} {n}_{u} ( λ ) + {ρ}^{″} {n}_{f} ( λ ) ,$$
$${k}_{1} ( λ ) = {ρ}^{′} {k}_{u} ( λ ) + {ρ}^{″} {k}_{f} ( λ ) ,$$
$${ρ}^{′} + {ρ}^{″} = 1 ,$$
wherein, λ represents a wavelength of light; n₁(λ) represents the calculated effective index of the filled unit cells; k₁(λ) represents the calculated equivalent extinction coefficient of the filled unit cells; nᵤ(λ) represents a refractive index of the structures; n_{f} (λ) represents a refractive index of the filler material; kᵤ(λ) represents an extinction coefficient of the structures; k_{f}(λ) represents an extinction coefficient of the filler material; ρ′ represents a ratio of an area of the structures to an area of the respective filled unit cells; and ρ″ represents a ratio of an area of the filler material to the area of the respective filled unit cells.

5. The method according to claim 2, wherein a step of “obtaining the effective refractive index and the equivalent extinction coefficient by the direct calculation” comprises:
calculating the effective refractive index and the equivalent extinction coefficient by following formulae:
$${n}_{1} ( λ ) = \frac{- {λ}^{2}}{2 π h} \cdot \frac{d φ ( λ )}{d λ} + 1 ,$$
$${k}_{1} ( λ ) = \frac{1}{h} ln \frac{T ( λ )}{{T}_{0}} ,$$
wherein, h represents a height of the structures; To represents light intensity of incident light, φ(λ) represents a phase of the respective filled unit cells at different wavelengths; and
T(λ) represents transmittance of the respective filled unit cells at different wavelengths.

6. The method according to claim 1, wherein a step of “obtaining the refractive index and the extinction coefficient of the filled metalens by calculating the weighted average of the effective refractive index and the equivalent extinction coefficient” comprises:
calculating the refractive index and the extinction coefficient of the filled metalens by following formulae:
$$n ( {λ}_{j} ) = {Σ}_{i = 1 , j = 1}^{M \times N} {C}_{ij} {n}_{i} ( {λ}_{j} ) ,$$
$$k ( {λ}_{j} ) = {Σ}_{i = 1 , j = 1}^{M \times N} {C}_{ij} {k}_{i} ( {λ}_{j} ) ,$$
wherein, c represents a weighting coefficient; M represents a number of the filled unit cells in the metalens; N represents a number of selected wavelengths; n(λ) represents the effective refractive index; and k(λ) represents the equivalent extinction coefficient.

7. The method according to claim 1, wherein the initial anti-reflection film comprises a plurality of initial anti-reflection layers; the parameter of the initial anti-reflection film comprises a number of the initial anti-reflection layers; a thickness of each initial anti-reflection layer and a material of each initial anti-reflection layer.

8. The method according to claim 3, wherein the optimization iteration comprises an interior point method, a steepest descent method and a Newton's method.

9. The method according to claim 1, wherein the anti-reflection film comprises a plurality of anti-reflection layers; the optimized parameter of the anti-reflection film comprises an optimized number of the anti-reflection layers; an optimized thickness of each anti-reflection layer and an optimized material of each anti-reflection layer.

10. The method of claim 7, wherein the number of layers of the initial anti-reflection film is four; the initial anti-reflection film comprises a first layer, a second layer, a third layer and a fourth layer sequentially arranged; the first layer is closest to a metasurface; the fourth layer is farthest from the metasurface; and
a material of the first layer and a material of the third layer are titanium oxide; a material of the second layer and a material of the fourth layer are silicon oxide.

11. The method according to claim 10, wherein the first layer, the second layer, the third layer and the fourth layer at least satisfy a following relational expression:
a thickness of the fourth layer<a thickness of the first layer≤a thickness of the second layer<a thickness of the third layer.

12. The method according to claim 9, wherein the optimized number of layers of the anti-reflection film is six; the anti-reflection film comprises a first layer, a second layer, a third layer, a fourth layer, a fifth layer and a sixth layer sequentially arranged; the first layer is closest to a metasurface; the sixth layer is farthest from the metasurface; and
a material of the first layer and a material of the fifth layer are titanium oxide; a material of the second layer, a material of the fourth layer and a material of the sixth layer are silicon oxide;
and a material of the third layer is thallium oxide.

13. The method of claim 12, wherein the first layer, the second layer, the third layer, the fourth layer, the fifth layer and the sixth layer at least satisfy a following relational expression:
a thickness of the fifth layer≤a thickness of the third layer≤a thickness of the first layer<a thickness of the sixth layer<a thickness of the second layer≤a thickness of the fourth layer.

14. A method for coating an anti-reflection film of a metalens, using the method of claim 1, comprising:
step 1: filling a gap between the structures with the filler material until the filled metalens has the flat surface; and
step 2: coating the anti-reflection film on the flat surface of the filled metalens.

15. An anti-reflection film of a metalens, designed by the method of claim 1.

16. A metalens, comprising the anti-reflection film of claim 15.

17. A device for designing an anti-reflection film of a metalens, wherein the device comprises a calculation module and an anti-reflection film optimization module;
the calculation module is configured to calculate a refractive index and an extinction coefficient of a filled metalens based on a refractive index of structures, an extinction coefficient of the structures, a refractive index of a filler material and an extinction coefficient of the filler material; wherein the structures are in microscale or nanoscale; and
the anti-reflection film optimization module is configured to calculate a parameter of an initial anti-reflection film based on the refractive index of the filled metalens and the extinction coefficient of the filled metalens, and the anti-reflection film optimization module is also configured to perform an optimization iteration on the parameter of an initial anti-reflection film, so as to obtain an optimized parameter of the anti-reflection film.

18. The device according to claim 17, wherein the anti-reflection film optimization module comprises an anti-reflection film calculation module and a finite element analysis module;
the anti-reflection film calculation module is configured to calculate the parameter of the initial anti-reflection film;
the finite element analysis module is configured to obtain a light field phase and transmittance based on the parameter of the initial anti-reflection film; and
the anti-reflection film calculation module and the finite element analysis module together perform an optimization iteration on the parameter of the initial anti-reflection film calculated by the anti-reflection film calculation module, so as to obtain an optimized parameter of the anti-reflection film.

19. An electronic device, comprising: a bus, a transceiver, a memory, a processor and a computer program;
wherein the computer program is stored in the memory and executable on the processor; the transceiver, the memory and the processor are connected through the bus; the computer program is executed by the processor, so as to implement the method of claim 1.

20. A non-transitory computer-readable storage medium in which a computer program is stored, wherein the computer program is executed by a processor, so as to implement the method of claim 1.
